(19) United States
(12) Patent Application Publication
(10) Pub. No.: US 2006/0155399 A1
(43) Pub. Date: Jul. 13, 2006

(54) Method and system for generating acoustic fingerprints

(76) Inventor: Sean Ward, Alexandria, VA (US)

Correspondence Address: Sean Ward;Relatable, 14 West Cedar Street, Alexandria, VA, 22301, US

(21) Appl. No.: 10/525,389

(22) PCT Filed: Aug. 25, 2004
(86) PCT No.: PCT/US04/27452

§ 371 Date: Feb. 25, 2005

Related U.S. Application Data
(60) Provisional application No. 60/497,328, filed on Aug. 25, 2003.

(51) Int. Cl. G06F 17/00

(52) U.S. Cl. 700/94

(57) ABSTRACT

A method and system for generating an acoustic fingerprint of a digital audio signal is presented. A received digital audio signal is downsampled, based upon a predetermined frequency, and then subdivided into a beginning portion, a middle portion and an end portion. A plurality of beginning frames, a plurality of middle frames and a plurality of end frames, each having a predetermined number of samples, are extracted from the beginning, middle and end portions of the downsampled, digital audio signal, respectively. A plurality of frame vectors, each having a plurality of spectral residual bands and a plurality of time domain features, are generated from the plurality of beginning, middle and end frames, and an acoustic fingerprint of the digital audio signal is created based on the plurality of frame vectors. The acoustic fingerprint is then stored in a database.

### CLAIM FOR PRIORITY/CROSS-REFERENCE TO RELATED APPLICATIONS

This application claims priority to U.S. Provisional Patent Application Ser. No. 60/497,328 (filed Aug. 25, 2003), which is incorporated herein by reference in its entirety. This application is related to U.S. Non-provisional patent application Ser. No. 09/931,859 (filed Aug. 20, 2001, now abandoned), which is incorporated herein by reference in its entirety.

### TECHNICAL FIELD

The present invention relates to digital signal processing. More specifically, the present invention relates to a method and system for generating acoustic fingerprints that represent perceptual properties of a digital audio signal.

### BACKGROUND OF THE INVENTION

Acoustic fingerprinting has historically been used primarily for signal recognition purposes, including, for example, terrestrial radio monitoring systems. Since these systems monitor continuous audio sources, acoustic fingerprinting solutions typically accommodated the lack of delimiters between given signals. However, these systems were less concerned with performance because a particular monitoring system did not need to discriminate between large numbers of signals, and functioned with primarily analog signal distortions. Additionally, these systems do not effectively process many of the common types of signal distortion encountered with compressed digital audio signals, such as normalization, small amounts of time compression and expansion, envelope changes, noise injection, and psycho acoustic compression artifacts.

There have been various attempts to automate audio sequencing, ranging from collaborative filtering and metadata driven solutions, to human or rules-based classification, to machine-listening systems. These have suffered from various deficiencies, including laborious human dassification, large amounts of user preference training data, an inability to handle unknown unclassified audio, usage of a single description for an entire audio work, etc. None have been able to flexibly index audio from radio, microphone sources, digital libraries, and internet sources in a heterogeneous manner. Additionally, while some have addressed the issue of finding similar works, they are unable to sequence result lists as well, due to a lack of temporal information in the audio description, especially when comparing works of varying lengths.

### SUMMARY OF THE INVENTION

Embodiments of the present invention are directed to a method and system for generating an acoustic fingerprint of a digital audio signal. A received digital audio signal is downsampled, based upon a predetermined frequency, and then subdivided into a beginning portion, a middle portion and an end portion. A plurality of beginning frames, a plurality of middle frames and a plurality of end frames, each having a predetermined number of samples, are extracted from the beginning, middle and end portions of the downsampled, digital audio signal, respectively. A plurality of frame vectors, each having a plurality of spectral residual bands and a plurality of time domain features, are generated from the plurality of beginning, middle and end frames, and an acoustic fingerprint of the digital audio signal is created based on the plurality of frame vectors. The acoustic fingerprint is then stored in a database.

### BRIEF DESCRIPTION OF THE DRAWINGS

FIG. 1 is a logic flow diagram, showing the basic, batched model of building a reference SoundsLike print database, according to an embodiment of the present invention.

FIG. 2 is a logic flow diagram, giving an overview of the audio stream preprocessing step, according to an embodiment of the present invention.

FIG. 3 is a logic flow diagram, giving more detail of the SoundsLike print generation step, according to an embodiment of the present invention.

FIG. 4 is a logic flow diagram, giving more detail of the time domain feature extraction step, according to an embodiment of the present invention.

FIG. 5 is a logic flow diagram, giving more detail of the spectral domain feature extraction step, according to an embodiment of the present invention.

FIG. 6 is a logic flow diagram, giving more detail of the beat tracking finalization step, according to an embodiment of the present invention.

FIG. 7 is a logic flow diagram, giving more detail of the second stage FFT feature step, according to an embodiment of the present invention.

FIG. 8 is a logic flow diagram, giving more detail of the frame finalization step, including spectral band residual computation, and wavelet residual computation and sorting, according to an embodiment of the present invention.

FIG. 9 is a block diagram that illustrates a system architecture that according to an embodiment of the present invention.

FIG. 10 is a block diagram that illustrates the architecture of the SoundsLike print database component, according to an embodiment of the present invention.

FIG. 11 is a logic flow diagram, giving more detail of the SoundsLike print comparison process, according to an embodiment of the present invention.

FIG. 12 is a logic flow diagram, giving more detail of the feature frame comparison function, according to an embodiment of the present invention.

FIG. 13 is a logic flow diagram, showing the SoundsLike print ordering process, according to an embodiment of the present invention.

FIG. 14 is a top level flow diagram that illustrates a method for generating an acoustic fingerprint of a digital audio signal, according to an embodiment of the present invention.

### DETAILED DESCRIPTION

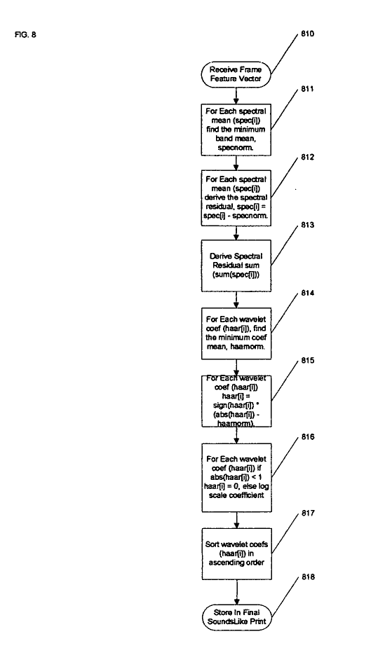

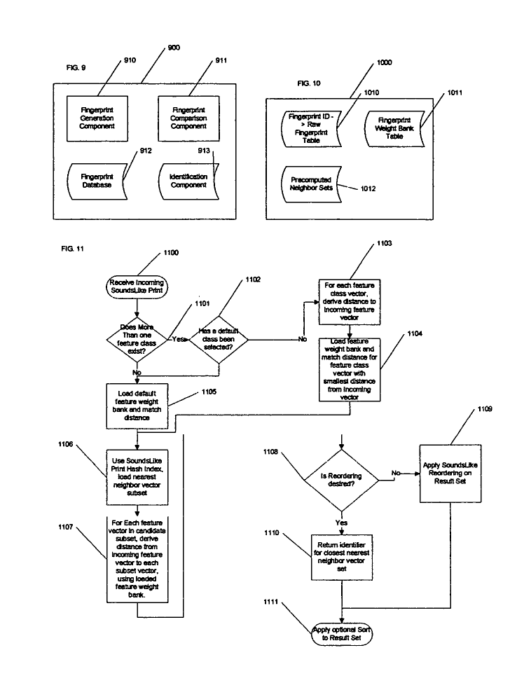

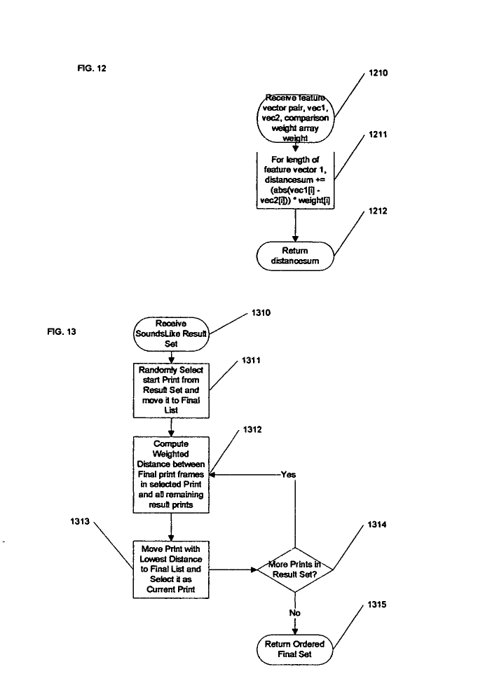

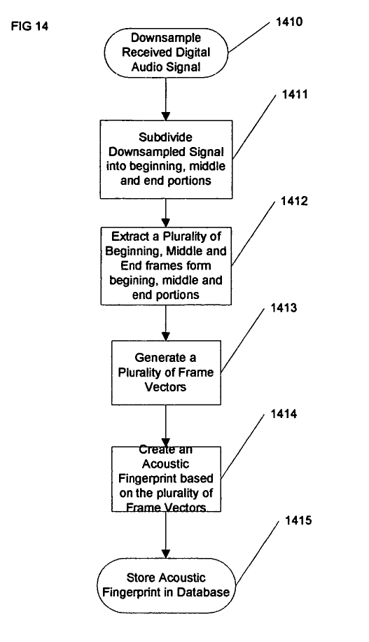

FIG. 9 depicts a block diagram that illustrates a system architecture according to an embodiment of the present invention. System 900 may include acoustic fingerprint generation module 910, acoustic fingerprint comparison module 911, and acoustic fingerprint reference database 912. Acoustic fingerprint identification module 913 may also be provided. Acoustic fingerprint generation module 910, acoustic fingerprint comparison module 911 and acoustic fingerprint identification module 913 may be implemented as software components, hardware components or any combination thereof. Generally, system 900 may be coupled to a network. In an embodiment, acoustic fingerprint generation module 910, acoustic fingerprint comparison module 911, acoustic fingerprint reference database 912 and acoustic fingerprint identification module 913 may be individually coupled to a network, or to each other, in various ways (not shown in FIG. 9).

According to various embodiments of the present invention, acoustic fingerprints are created from a digital audio sound stream, which may originate from a digital audio source such as, for example, a compressed or non-compressed audio datafile, a CD, a radio broadcast, a microphone, etc. In one embodiment, acoustic fingerprint comparison module 911 and acoustic fingerprint reference database 912 are located on a central network server (not shown in FIG. 9) in order to provide access to multiple, networked users, while in another embodiment, acoustic fingerprint generation module 910, acoustic fingerprint comparison module 911 and acoustic fingerprint reference database 912 reside on the same computer (as generally shown in FIG. 9).

Acoustic fingerprint comparison module 911 may precompute results for each acoustic fingerprint in acoustic fingerprint reference database 912, using one or more weight sets, in order to support quick retrieval of search results on devices with low processing power, such as, for example, portable audio players. Acoustic fingerprint identification module 913 may map a short input (such as a 30 second microphone capture, or a hummed query) to a full, reference acoustic fingerprint.

Acoustic fingerprints may be formed by subdividing a digital audio stream into discrete frames, from which various temporal and spectral features, such as, for example, zero crossing rates, spectral residuals, Haar wavelet residuals, trailing spectral power deltas, etc., may be extracted, summarized, and organized into frame feature vectors. In a preferred embodiment, several constant length frames are extracted from the beginning, middle, and end of a digital acoustic signal and sampled at locations proportionate to the length of the signal. In a further embodiment, the middle frames may be created by averaging one or more constant length feature frames to produce a constant length acoustic fingerprint, which advantageously allows variable-length musical works (i.e., digital audio signals) to be compared while maintaining each works' temporal features, including, for example, transition information. Song reordering, based on acoustic fingerprint comparisons using subsets of frames, as well as overall similarity searching, may be provided.

In one embodiment, acoustic fingerprints are compared by calculating a weighted Manhattan distance between a given pair of acoustic fingerprints. Additionally, comparisons focusing on a subset of frames, such as, for example, comparing the beginning portion of an acoustic fingerprint to the end portions of other acoustic fingerprints, may be used to determine similarity for sequencing, for example. In one embodiment, comparisons are performed on a nearest neighbor set of acoustic fingerprints by acoustic fingerprint comparison module 911, and identifiers are then associated with each element of acoustic fingerprint reference database 912. Acoustic fingerprint comparison module 911 may provide the appropriate identifiers when a set of similar acoustic fingerprints is found.

In a preferred embodiment, a similarity query is performed in response to the activation of a button on a digital audio playback device, or in a graphical interface of the device, such as, for example, a “SoundsLike” button on a portable digital audio player. The similarity query may include, for example, the currently playing song, the currently selected song in a browser, etc., and may be directed to a local acoustic fingerprint reference database residing on the digital audio playback device, or, alternatively, to a remote acoustic fingerprint database residing on a network server, such as, for example, acoustic fingerprint reference database 912. Additionally, the results returned by the similarity query, i.e., the matching acoustic fingerprints, may be sequenced to create a music playlist for the digital audio playback device.

In one embodiment, acoustic fingerprint generation module 910 may reside within a database system, a media playback tool, portable audio unit, etc. Upon receiving unknown content, acoustic fingerprint generation module 910 generates an acoustic fingerprint, which may be sent to acoustic fingerprint comparison module 911 over network, for example. Acoustic fingerprint generation may also occur at synchronization time, such as, for example, when a portable audio player is “docked” with a host PC, and acoustic fingerprints may be generated from each digital audio file as they are transmitted from the host PC to the portable audio player.

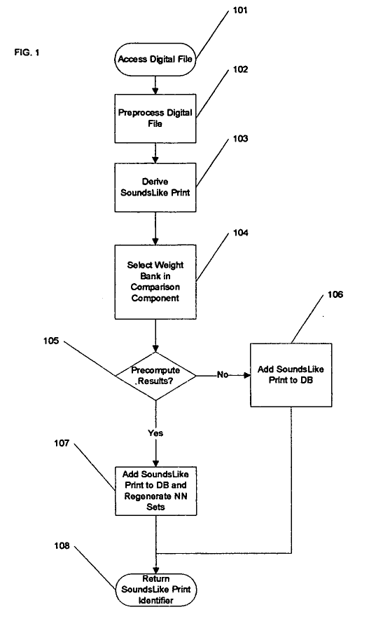

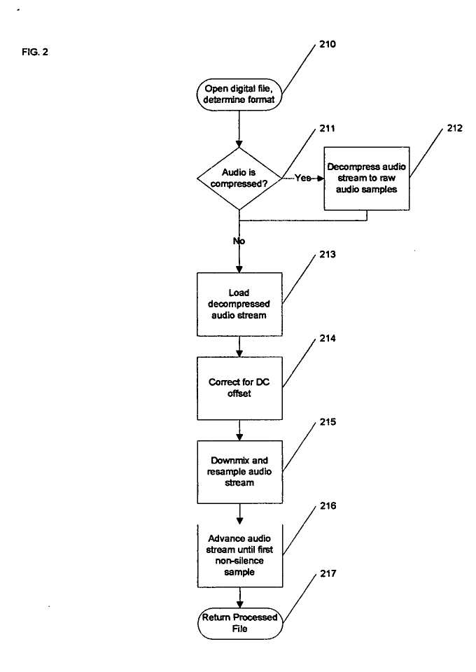

FIG. 1 is a top level flow diagram that illustrates a method for generating an acoustic fingerprint of a digital audio signal, according to an embodiment of the present invention.

Processing a media data file (i.e., digital audio signal) may include opening the file, identifying the file format, and if appropriate, decompressing the file. The decompressed digital audio data stream may then be scanned for a DC offset error, and if one is detected, the offset may be removed. Following the DC offset correction, the digital audio data stream may be downsampled to 11025 Hz, which also provides low pass filtering of the high frequency component of the digital audio signal. In an embodiment, the downsampled, digital audio data stream is downmixed to a mono stream. This step advantageously speeds up extraction of acoustic features and eliminates high frequency noise components introduced by compression, radio broadcast, environmental noise, etc. In one embodiment, acoustic fingerprint generation module 910 processes the file directly, while in another embodiment, the downsampled, downmixed digital audio signal is processed by a media data file preprocessing module (not shown in FIG. 9), and then transmitted to acoustic fingerprint generation module 910. Other digital audio sources may be subjected to similar initial processing.

Acoustic fingerprints may be formed by subdividing (1411) a digital audio stream into a beginning portion, a middle portion and an end portion. In one embodiment, a window frame size of 96,000 samples may be used, with a frame overlap percentage of 0%. Extracting (1412), or sampling, 5 frames from the beginning portion of the digital audio signal, 3 frames from the midpoint of the digital audio signal, and 5 frames from the end of the digital audio signal provides a very effective frame vector creation method. In cases where the temporal length of the digital audio signal is less than the time required to generate an acoustic fingerprint without frame overlap, front, middle, and end frames may be overlapped. Alternatively, when the temporal length of the digital audio signal is less than the time required for front, middle and end frame sets, the middle and end frame sets may be omitted, and only a proportionate number of front frames may be extracted. In the embodiment including a window frame size of 96,000 samples and a sampling rate of 11,025 Hz, a minimum digital audio signal length of approximately 9 seconds is required to generate a single frame. This frame methodology may be optimized for music, and modification of frame size and frame count may be performed to accommodate smaller digital audio signals, such as, for example, sound effects.

In another embodiment, the middle frames may be extracted from all of the digital audio available in the middle of the digital audio signal. Continuous feature frames may be extracted, starting from the end of the beginning frame set and ending at the beginning of the end frame set. The total number of continuous frames may then be divided by a constant, and the result is used to determine how many frames are averaged together to create an averaged middle frame. For example, given 3 desired middle frames and 72 seconds of middle portion digital audio, 9 frames would be initially extracted and averaged together, in groups of 3 frames, to create the desired 3 middle frames. Advantageously, averaging the middle portion of the digital audio signal provides a better representative of the middle portion of a musical work, although with a higher computational cost for acoustic fingerprint creation.

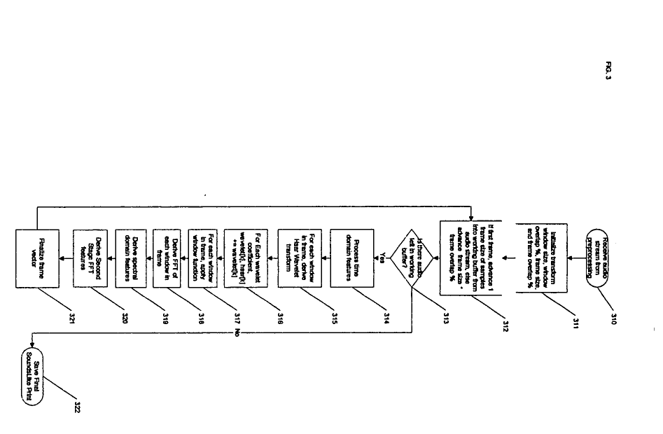

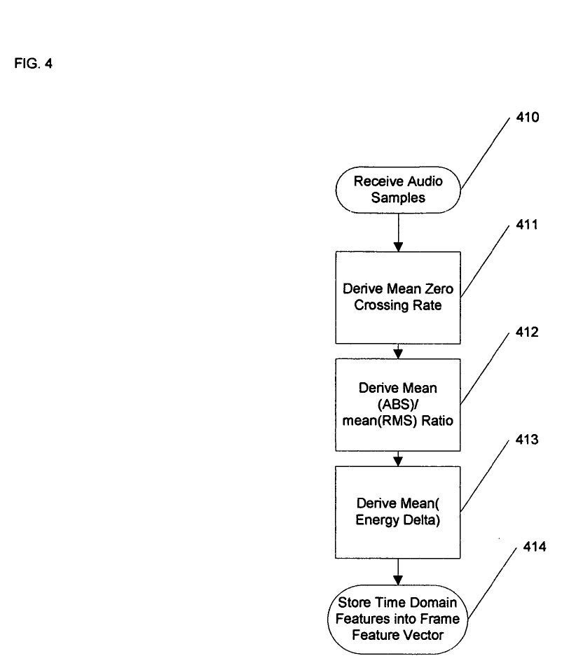

Generally, a plurality of frame vectors is generated (1413) from the plurality of beginning, middle and end frames, and the acoustic fingerprint of the digital audio signal is created (1414) from these frame vectors. The acoustic fingerprint may then be stored (1415) in a database, such as, for example, acoustic fingerprint reference database 912. A more detailed description of the generation of the frame vectors follows with respect to FIGS. 3 through 8.

FIGS. 3 through 8 are top level flow diagrams that illustrate methods for generating an acoustic fingerprint of a digital audio signal, according to embodiments of the present invention.

In an embodiment, the window frame size samples are advanced into a working buffer (313). The time domain features of the working frame vector are then computed (314). The zero crossing rate is computed by storing the sign of the previous sample, and incrementing a counter each time the sign of the current sample is not equal to the sign of the previous sample, with zero samples ignored. The zero crossing total is then divided by the frame window length, to compute the zero crossing mean feature. The absolute value of each sample is also summed into a temporary variable, which is also divided by the frame window length to compute the sample mean value. This result is divided by the root-mean-square of the samples in the frame window, to compute the mean/RMS ratio feature. Additionally, the mean energy value is stored for each block of 10624 samples within the frame. The absolute value of the difference from block to block is then averaged to compute the mean energy delta feature.

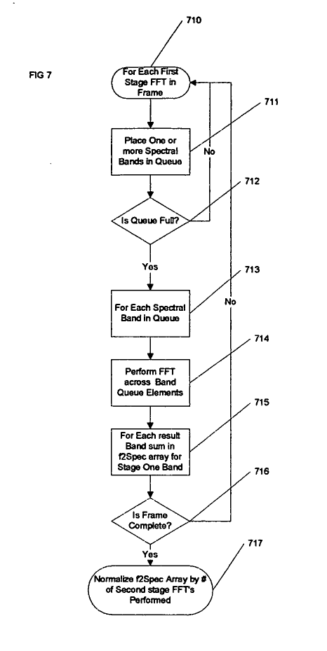

Next, a wavelet transform, such as, for example, a Haar wavelet transform, with transform size of 64 samples, using, for example, ½ for the high pass and low pass components of the transform, is applied (315) to the frame audio samples. Each transform may be overlapped by 50%, and the resulting coefficients are summed into a 64 point array. The number of transforms that have been performed then divides each point in the array, and the minimum array value is stored as the normalization value. The absolute value of each array value minus the normalization value is then stored in the array, any values less than 1 are set to 0, and the final array values are converted to log space using the equation array[I]=20*log10(array[I]). These log scaled values are then sorted (321, detail FIG. 8) into ascending order, to create a wavelet domain feature bank.

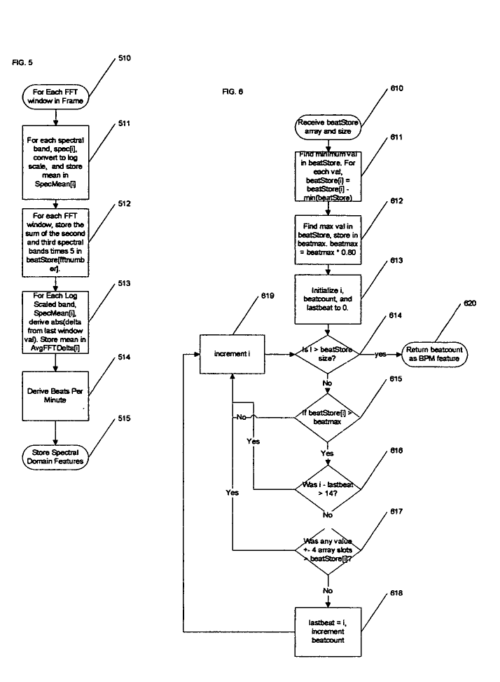

Subsequent to the wavelet computation, a window of 64 samples in length is applied (317), such as, for example, a Blackman-Harris window, and a Fast Fourier transform is applied (318). The resulting power bands are summed in a 32 point array, converted (319) to a log scale using the equation spec[I]=log10(spec[I]/4096)+6, and then the difference from the previous transform is summed in a companion spectral band delta array of 32 points. This is repeated, with a 50% overlap between each transform, across the entire frame window. Additionally, after each transform is converted to log scale, the sum of the second and third bands, times 5, is stored in an array (e.g., “beatStore”), indexed (detail FIG. 6) by the transform number.

After the other features have been extracted, a two-stage Fourier transform may then be applied (320). The first stage transform is performed on a 512 point unwindowed sample block across the entire frame window, with a 85% overlap between each transform. Alternatively, a Blackman-Harris window may be used. The third power band of each first stage Fourier transform may be stored in a queue structure limited, for example, to 512 elements. Once the queue structure is full with 512 elements (i.e., in this embodiment, every 44 first stage transforms), the second stage Fourier transform is performed on the 512 output data points of the first stage transform. The first 32 power bands of the second stage transform are summed in an array (e.g., “f2Spec”). After the last first stage Fourier transform, the array is divided by the number of second stage transforms to produce the mean average. Selection of different first stage bands for input to the second stage process is also possible, and the usage of a wavelet or DCT transform to summarize the second stage is also contemplated.

After the calculation of the last Fourier transform, the indexed array (e.g., “beatStore”) may be processed using a beat tracking algorithm. The minimum value in the array is found, and each array value is adjusted such that array[I]=array[I]−minimum val. Then, the maximum value in the array is found, and a constant, (e.g., “beatmax”) is defined to be 80% of the maximum value in the array. For each value in the array which is greater than the constant, if all the array values+−4 array slots are less than the current value, and it has been more than 14 slots since the last detected beat, a beat is detected and the beat per minute, or BPM, feature is determined (FIG. 6). More precise beat tracking methods may also be utilized.

Upon completing the spectral domain calculations, the frame finalization process may be performed and the acoustic fingerprint created (321). First, the spectral power band means are converted (812) to spectral residual bands by finding the minimum spectral band mean, and subtracting it from each spectral band mean. Next the sum of the spectral residuals may be stored as the spectral residual sum feature. Finally, depending on the aggregation type, the acoustic fingerprint, consisting of the spectral residuals, the spectral deltas, the sorted wavelet residuals, the beat feature, the mean/RMS ratio, the zero crossing rate, and the mean energy delta feature may be stored (818).

In a preferred embodiment, acoustic fingerprint comparison module 911 may reside within a music management application, such as synchronization software for a portable music player. In this embodiment, the media file contains the digital audio signal. Upon receiving the new acoustic fingerprint from acoustic fingerprint generation module 910, the acoustic fingerprint may be associated with a media key specific to the media data file from which the acoustic fingerprint was extracted. Alternatively, a check may be performed to determine whether the acoustic fingerprint is a duplicate, e.g., identical, within a particular similarity threshold, etc., of any existing acoustic fingerprints in the associated fingerprint database, such as, for example, acoustic fingerprint reference database 912. Depending on memory and response time requirements, the nearest neighbor set for the new acoustic fingerprint may be calculated using one or more weight banks and acoustic fingerprint reference database 912. This precomputed, nearest neighbor set may then be stored in acoustic fingerprint reference database 912, along with the new acoustic fingerprint and media identifier.

In one embodiment, after generating acoustic fingerprints and optionally precomputing nearest neighbor sets for each media file that has been added to the management application, or is pending synchronization to the media player, acoustic fingerprint reference database 912 may be uploaded to the media player. This allows the more computationally expensive generation and comparison processes to be performed on the faster host PC, leaving only query operations on the portable device.

A query (e.g., a “SoundsLike” query) may take several forms, depending upon the host device and audio type. In the case of a portable audio player, a button may be pressed when any track is selected in the browse listing, or a when a track (i.e., a digital audio signal) is currently being played back. Upon depression of the “SoundsLike” button, the associated media ID for the currently selected, or currently playing, media file is retrieved and passed to a “SoundsLike” database module on the device. If no nearest neighbor set has been precomputed, the acoustic fingerprint database (e.g., acoustic fingerprint database 912) may be loaded and the currently selected weight bank may be used to find the closest acoustic fingerprints to the acoustic fingerprint associated with the query media ID. Alternatively, if the nearest neighbor set has been precomputed, an index may be used to jump directly to the precomputed set of media ID's that are most similar in the current weight set to the query media ID. This set is then returned to the media player, which proceeds to create a playlist from the associated media files for each media ID.

If the portable audio device is receiving an unindexed digital audio signal, such as, for example, a radio, microphone, internet stream, line-in source, etc., then an acoustic fingerprint may be created from the input digital audio stream, preferably using 13 window frame samples of digital audio for the acoustic fingerprint, as discussed above. This acoustic fingerprint may then be added to acoustic fingerprint reference database 912 and a query can then be performed. In this embodiment, acoustic fingerprint generation module 910 and acoustic fingerprint comparison module 911 both reside on the portable audio device (as software components, for example). This allows a device to integrate any source of digital audio into the query process for a user, such as seeding a playlist from a user's personal audio collection from a song they hear on the radio, or in a club.

In the event that the input digital audio source contains insufficient material to generate an acceptable acoustic fingerprint, in one embodiment, acoustic fingerprint identification module 913 may map the input digital audio signal to a known acoustic fingerprint, while in another embodiment, acoustic fingerprint identification module 913 may interpret a melodic pattern from the input digital audio signal (e.g., a hummed tune). In both embodiments, the resulting identifier returned by acoustic fingerprint identification module 913 may be used to retrieve a reference acoustic fingerprint stored in acoustic fingerprint reference database 912.

In a further embodiment, a graphical user interface may be provided to allow the user of system 900 to select a weight bank to tune the system in different fashions. For instance, one weight bank may weight the lower frequency features, such as the first few second stage FFT features and the beat feature, higher than the vocal range features, in order to focus a search on tempo and rhythm characteristics in the fingerprint, while another may weight the features more evenly for a blended search that takes vocals, instrumentation, and rhythm into account. Additionally, a slider graphical interface, similar to a graphics equalizer, may be presented to the user to allow manual control over the weight banks, In this embodiment, each slider may be associated with one or more features to manual tune acoustic fingerprint comparisons.

In another embodiment, a “more like this” “less like this” feature may be provided, in which acoustic fingerprint comparison module 911 receives and processes two acoustically fingerprinted tracks and shifts the current weight bank to reduce the weight of dissimilar features in the selected acoustic fingerprints and raise the weight of similar features, as appropriate. This feature advantageously provides an intuitive mechanism for a non-technical user to further train acoustic fingerprint comparison module 911 to the user's individual tastes. Additional methods of weight adjustment, including, for example, allowing a user to select multiple acoustic fingerprints, training a weight set via a Bayesian filter or neural network, etc., are also contemplated by the present invention.

In a further embodiment, a sorting method may be used on nearest neighbor sets to create a playlist, including, for example, a random sort, sorting by similarity, a merge sort from two or more queries, a random merge from two or more queries, a thresholded merge from two or more queries (where the similarity factor for each duplicate item in the merged sets is summed for each item which exists in more than one query set, and items below a certain threshold are removed from the final list), a acoustic fingerprint-based sort, etc. In the acoustic fingerprint-based sort, for example, a special comparison may be performed between the acoustic fingerprints within the result set, where the first and last sets of feature vectors in each acoustic fingerprint are compared to all of the other acoustic fingerprints in the result set, with the resulting sort order based on the minimization of the weighted error between the first and last part of each acoustic fingerprint. This sort may include selecting a seed track, and for each of the other acoustic fingerprints, finding the acoustic fingerprint with the smallest error, and then repeating the process until each acoustic fingerprint has been moved into the result list. In yet another embodiment, additional metadata, such as genre or album, or perceptual metadata, such as emotional or sonic descriptors, may be used as a final filter on the result set.

Generally, the above-described systems and methods may be implemented on a computer server, personal computer, in a distributed processing environment, or the like, or on a separate programmed general purpose computer having database management and user interface capabilities. Additionally, the systems and methods of this invention may be implemented on a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, or the like, or a neural network and/or through the use of fuzzy logic. In general, any device capable of implementing a state machine that is in turn capable of implementing the flowcharts illustrated herein may be used to implement the invention.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or a VLSI design. Whether software or hardware is used to implement the systems in accordance with this invention is dependent on the speed and/or efficiency requirements of the system, the particular function, and the particular software or hardware systems or microprocessor or microcomputer systems being utilized. The systems and methods illustrated herein however can be readily implemented in hardware and/or software using any known or later developed systems or structures, devices and/or software by those of ordinary skill in the applicable art from the functional description provided herein and with a general basic knowledge of the computer and data processing arts.

Moreover, the disclosed methods may be readily implemented in software executed on programmed general purpose computer, a special purpose computer, a microprocessor, or the like. Thus, the systems and methods of this invention can be implemented as program embedded on personal computer such as JAVA® or CGI script, as a resource residing on a server or graphics workstation, as a routine embedded in a dedicated system, or the like. The system can also be implemented by physically incorporating the system and method into a software and/or hardware system, such as the hardware and software systems.

While this invention has been described in conjunction with specific embodiments thereof, many alternatives, modifications and variations will be apparent to those skilled in the art. Accordingly, the preferred embodiments of the invention as set forth herein, are intended to be illustrative. Various changes may be made without departing from the true spirit and full scope of the invention as set forth herein.

What is claimed is:

1. A method for generating an acoustic fingerprint of a digital audio signal, comprising:
downsampling a received digital audio signal based upon a predetermined frequency;
subdividing the downsampled, digital audio signal into a beginning portion, a middle portion and an end portion;
extracting a plurality of beginning frames, a plurality of middle frames and a plurality of end frames from the beginning, middle and end portions of the downsampled, digital audio signal, respectively, each frame having a predetermined number of samples;
generating a plurality of frame vectors from the plurality of beginning, middle and end frames, each frame vector including a plurality of acoustic features;
creating an acoustic fingerprint of the digital audio signal based on the plurality of frame vectors; and
storing the acoustic fingerprint in a database.

2. The method according to claim 1, wherein said generating a frame vector for each frame includes:
computing a plurality of time domain features from the predetermined number of samples within the frame;
computing a plurality of spectral domain features from the predetermined number of samples within the frame;
computing a plurality of wavelet domain features from the predetermined number of samples;
computing a plurality of second stage spectral features from the predetermined spectral domain FFT results; and
creating the frame vector.

3. The method according to claim 2, wherein said generating a frame vector for each frame includes:
Applying a logarithmic conversion to the plurality of spectral power bands;
Creating an indexed array based on the plurality of log-converted spectral power bands;
Determining a number of beats within the indexed array; and
Including the number of beats within the frame vector.

4. The method according to claim 2, wherein the wavelet domain features include using a Haar wavelet transform, using a Blackman-Harris window.

5. The method according to claim 1, further comprising:
Downmixing the downsampled audio signal to create a single channel, downsampled digital audio signal.

6. The method according to claim 2, wherein the predetermined frequency is about 11025 hz.

7. The method according to claim 2, wherein:
The predetermined number of samples is about 96,000;
The plurality of beginning frames includes five frames;
The plurality of middle frames includes three frames; and
The plurality of end frames includes five frames.

8. The method according to claim 1, wherein said extracting a plurality of middle frames includes:
Determining a total number of frames within the plurality of middle frames;
Calculating a number of frames to average by dividing the total number of frames by a constant; and
Averaging the plurality of middle frames, based on the number of frames to average, to create the constant number of frames.

9. The method according to claim 1, wherein the plurality of time domain features include a zero crossing rate, a zero crossing mean, a sample mean and RMS ratio, a mean energy value, and a mean energy delta value.

10. A method for generating an acoustic fingerprint frame vector from a frame extracted from a digital audio signal, comprising:
Computing a plurality of time domain features from a plurality of samples within the frame;
Applying a window function to the plurality of samples;
Applying a Fast Fourier Transform to the plurality of windowed samples to create a plurality of spectral power bands;
Determining the number of beats from the spectral power bands;
Selecting one or more output spectral power bands and using one or more first stage FFT outputs as input for a second Fast Fourier Transform;
Selecting one or more output second stage power bands, summing across all output second stage Fast Fourier Transforms, and normalizing the resulting sum by the number of input Transforms;
Creating an acoustic fingerprint frame vector including the plurality of second stage normalized bands, the plurality of time domain features and the number of beats; and
Storing the acoustic fingerprint frame vector in a memory.

11. The method according to claim 10, wherein the plurality of time domain features include a zero crossing rate, a zero crossing mean, a sample mean and RMS ratio, a mean energy value, and a mean energy delta value.

12. The method according to claim 10, wherein the wavelet domain features include using a Haar wavelet transform, using a Blackman-Harris window.

13. The method according to claim 10, wherein the plurality of samples consists of about 96,000 samples.

14. An information storage medium storing information operable to perform the method of any of the preceding claims.

15. A system as substantially herein described.

16. A system for generating an acoustic fingerprint of a digital audio signal, comprising:
means for downsampling a received digital audio signal based upon a predetermined frequency;
means for subdividing the downsampled, digital audio signal into a beginning portion, a middle portion and an end portion;
means for extracting a plurality of beginning frames, a plurality of middle frames and a plurality of end frames from the beginning, middle and end portions of the downsampled, digital audio signal, respectively, each frame having a predetermined number of samples;
means for generating a plurality of frame vectors from the plurality of beginning, middle and end frames, each frame vector including a plurality of spectral residual bands and a plurality of time domain features;
means for creating an acoustic fingerprint of the digital audio signal based on the plurality of frame vectors; and
means for storing the acoustic fingerprint in a database.

17. The system according to claim 16, wherein said means for generating a frame vector for each frame includes:
means for computing a plurality of time domain features from a plurality of samples within the frame;
means for applying a window function to the plurality of samples;
means for applying a Fast Fourier Transform to the plurality of windowed samples to create a plurality of spectral power bands;
means for determining the number of beats from the spectral power bands;
means for selecting one or more output spectral power bands, and using one or more first stage FFT outputs as input for a second Fast Fourier Transform;
means for selecting one or more output second stage power bands, summing across all output second stage Fast Fourier Transforms, and normalizing the resulting sum by the number of input Transforms;
means for creating an acoustic fingerprint frame vector including the plurality of second stage normalized bands, the plurality of time domain features and the number of beats; and
means for creating the frame vector.

18. The system according to claim 17, wherein said means for generating a frame vector for each frame includes:
means for applying a logarithmic conversion to the plurality of spectral power bands;
means for creating an indexed array based on the plurality of log-converted spectral power bands;
means for determining a number of beats within the indexed array; and
means for including the number of beats within the frame vector.

19. The system according to claim 17, wherein the wavelet domain features include using a Haar wavelet transform, using a Blackman-Harris window.

20. The system according to claim 17, wherein the predetermined number of samples consists of about 96,000 samples.

21. A method of sequencing digital media playback, comprising:
receiving a plurality of acoustic fingerprints as the seed;
selecting a weight bank for comparing the seed acoustic fingerprints;
comparing the seed fingerprint with a plurality of reference fingerprints using a selected weight bank;
selecting a subset of the reference fingerprints based on their similarity with the seed fingerprint;
applying a sort mechanism to the resultant subset; and
sequencing digital media playback using resultant sorted subset.

22. The method according to claim 21, wherein said selecting a weight bank includes:
comparing the seed fingerprint with a plurality of weight class reference vectors; and
selecting the weight class vector which is most similar to the seed fingerprint.

23. The method according to claim 21, wherein applying a sort mechanism includes:
randomly selecting a start acoustic fingerprint from the result set and moving it to the final sorted set;
computing the similarity between the last acoustic fingerprint in the sorted set and each remaining acoustic fingerprint in the result set;
moving the acoustic fingerprint with the highest similarity into the final sorted set; and
repeating until all acoustic fingerprints have been moved into the final sorted set.

24. The method according to claim 21, wherein applying a sort mechanism includes:
randomly selecting an acoustic fingerprint from the result set and moving it to the final sorted set; and
repeating until all acoustic fingerprints have been moved into the final sorted set.

25. The method according to claim 21, wherein sequencing digital media playback includes:
mapping each result acoustic fingerprint to a media identifier;
mapping each media identifier to a digital media element; and
generating a playlist containing the sorted digital media elements.

26. The method according to claim 21, wherein selecting a weight bank additionally adds the means to retrain a weight bank which includes:
providing a display component wherein a plurality of sliders elements are linked to one or more features within the selected weight bank.

27. The method according to claim 21, wherein selecting a weight bank additionally adds the means to retrain a weight bank which includes:
providing a user interface to allow a plurality of fingerprints to be marked as more similar;
comparing said plurality of fingerprints, and raising the weight of similar features by a scaling factor, and reducing the weight of dissimilar features by said scaling factor; and
normalizing the modified weights by said scaling factor.

28. The method according to claim 21, wherein selecting a weight bank additionally adds the means to retrain a weight bank which includes:
Providing a user interface to allow a plurality of fingerprints to be marked as less similar;
Comparing said plurality of fingerprints, and lowering the weight of similar features by a scaling factor, and raising the weight of dissimilar features by said scaling factor; and
Normalizing the modified weights by said scaling factor.

29. The method according to claim 21, wherein receiving a plurality of acoustic fingerprints as seed includes:
Generating an identification acoustic fingerprint from an input digital audio source;
Resolving the identification acoustic fingerprint using a reference acoustic fingerprint database to return a sequencing acoustic fingerprint identifier; and
Retrieving a reference sequencing acoustic fingerprint from a reference database using said sequencing acoustic fingerprint identifier.
